(19) United States
(12) Patent Application Publication
(10) Pub. No.: US 2008/0150885 A1
(43) Pub. Date: Jun. 26, 2008

(54) Bi-Stable Display

(75) Inventors: Mark Hurbert Frederik Overwijk, Eindhoven (NL); Siebe Tjerk De Zwart, Eindhoven (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/567,216

(22) PCT Filed: Jul. 30, 2004
(86) PCT No.: PCT/IB04/51341

§ 371 Date: Feb. 3, 2006

(30) Foreign Application Priority Data
Aug. 8, 2003 (EP) 03102485.4

(51) Int. Cl. G09G 3/34; G09G 3/20

(52) U.S. Cl. 345/107; 345/55

(57) ABSTRACT

A system comprises a rollable bi-stable display (RD), and a container for holding (HO) the rollable bi-stable display (RD) in a rolled up position, and for allowing the rollable bi-stable display (RD) to be unrolled., An addressing device (AD) locally addresses the rollable bi-stable display (RD) while being unrolled, while the not yet unrolled portion (UP) of the rollable bi-stable display (RD) is not yet addressed by the addressing device (AD).

The invention relates to a system comprising a bi-stable display, and to a method of addressing a bi-stable display. Such bi-stable displays are particular useful in mobile applications such as for example, PDA's, mobile phones and electronic books.

Rollable displays are very practical because a relatively small volume is required to store them in the rolled up state which greatly enhances the portability of this type of device. An important characteristic of bi-stable displays is that once an image is written into its pixels, this image can be retained for a long period of time without requiring any drive pulses. Thus, these bi-stable displays offer a low power consumption which also is very important in portable applications. However, to be able to determine the optical state of each one of the pixels independently, during an image update period when a new image is written into the display, the pixels need to be addressable separately. Therefore, usually, active matrix displays are required when a high number of pixels is required. Consequently, the display is quite complex due to need for intersecting select electrodes and data electrodes, and a transistor associated with each one of the intersections. Select drivers are required to select rows of pixels one by one and data drivers are required to supply the data to the pixels of the selected row.

It is an object of the invention to provide a bi-stable display which is less complex.

To achieve this object, a first aspect of the invention provides a system comprising a bi-stable display as claimed in claim 1. A second object of the invention provides a method of addressing a bi-stable display as claimed in claim 20. Advantageous embodiments are defined in the dependent claims.

The system in accordance with the first aspect of the invention comprises a bi-stable display (further also referred to as the display) and an addressing unit which is able to locally address the display. The information is written to the display by moving the addressing unit and the display with respect to each other. During an image update action when the image on the display has to be updated, an addressing device locally addresses the display while the addressing means and the display are moving with respect to each other. At a particular instant, only the part of the display which is associated with the addressing device is addressed. Thus the portion of the display which did not pass the addressing device is not yet addressed by the addressing device to display the new information of this image update period. The already addressed portion of the display will keep the information written by the addressing device earlier because of the bi-stable character of the display. The display pixels need not be selected row by row to be able to write the data to the selected row. The data is provided by the addressing device to only the portion of the display where the addressing device is active. The complete display will be addressed as it passes the addressing device during the movement of the addressing device and the display with respect to each other. Thus the display is completely addressed and displays the new picture when it completely passed the addressing device. The length of the display (defined as the amount of display which has to pass the addressing device) does not influence the complexity of the display and of the addressing device.

In an embodiment in accordance with the invention as defined in claim 2, the system comprises a rollable bi-stable display (further also referred to as the display). A mechanical construction holds the display when in a rolled up position and allows the display to be unrolled and preferably to be rolled up again. During an image update action when the image on the display has to be updated, an addressing device locally addresses the display while being unrolled. Only the part of the display which is associated with the addressing device is addressed. Thus the not yet unrolled portion of the display is not yet addressed by the addressing device to display the new information of the image update period. The already addressed portion of the display will keep the information written by the addressing device earlier because of the bi-stable character of the display. The display pixels need not be selected row by row to be able to write the data to the selected row. The data is provided by the addressing device to only the portion of the display where the addressing device is active. The complete display will be addressed as it passes the addressing device while being unrolled. Thus the display is completely addressed and displays the new picture when it is completely unrolled. If a new picture has to be displayed, the display has to be rolled up first to be able to address it again when being unrolled. The length of the display does not influence the complexity of the display and of the addressing device. It is also possible to write the new picture when rolling-up the display. The information written during the rolling-up may be kept during the unrolling.

By way of example only, in an embodiment in accordance with the invention, the display is operated as follows. During the unrolling of the display, the data is written to the pixels in the active area, which preferably is one line of pixels extending substantially perpendicular with respect to the direction of the movement of the display when it is unrolled. The line of pixels extends over the complete width of the display. After the information has been written to the line of pixels, due to the movement of the display, the same addressing device is able to write information to a next line of pixels by providing the data required for this line of pixels. Because the display is bi-stable, the information written in the previous line of pixels will be kept without requiring any drive voltages.

The bi-stable display in accordance with the invention need not be an active matrix display with intersecting select and data electrodes and with active elements associated with the intersections. Consequently, a simple display is possible which is cheap and may be thin. A thinner display may have the advantage that it is easy rollable.

Further, the addressing device can be simple because it only needs to address the display locally. The addressing device is not dependent on the length of the display. The length of the display is defined as the dimension of the display in the direction of the rolling, the dimension of the display perpendicular to the direction of rolling is referred to as the width. It is possible that the width is larger than the length of the display.

In an embodiment in accordance with the invention as defined in claim 3, the addressing device is a unit mechanically positioned separate from the bi-stable display. The display is addressed by moving the display and the addressing device with respect to each other. Preferably, the display is moved along the addressing device when rolled out or rolled into the holder. Alternatively, the addressing device may be moveably attached to the display.

In an embodiment in accordance with the invention as defined in claim 4, the addressing device is mechanically fixed to the holder. The display is addressed when it moves along the addressing device. In an embodiment in accordance with the invention as defined in claim 4 when referring to claim 2, the addressing device is mechanically fixed with respect to mechanical construction which allows the display to be stored when rolled up. Preferably, the addressing device is mounted in the mechanical construction which preferably is a container with a slit for pulling out the display. The addressing device may be mounted inside the container between the rolled up portion of the display and the slit. The addressing device may also be mounted onto the container at its outside near the slit. The display can be pulled out of the container by hand. It is also possible to provide a motor in the container which drives an axis on which the display is rolled up in the rolled up state.

The fixed position of the addressing device with respect to the container facilitates an easy synchronization between the movement of the display and the addressing of the addressing device such that the information is written into the correct position of the display.

In an embodiment in accordance with the invention as defined in claim 5, the addressing device is movably fixed to the holder to obtain at least two different positions with respect to the holder. If the addressing device is moveable in the direction perpendicular with respect of the movement direction of the display with respect to the addressing device, the addressing device need not be able to address complete lines of the display at the same time and thus will be less complicated. An embodiment in accordance with the invention wherein the addressing device is movable in the direction of movement of the display with respect to the addressing device is defined in claim 6.

In an embodiment in accordance with the invention as defined in claim 6, the addressing device is arranged in a first position with respect to the holder when the display is passing the addressing device for a first time, and the addressing device is arranged in a second position with respect to the holder when the display is passing the addressing device for a second time. The second position has an offset with respect to the first position in a direction of the movement. Now it is possible to improve the resolution of the information displayed by the display. During the second time the display passes the addressing device, the information is written to the display at positions in-between the positions addressed the first time the display passes the addressing device. It is possible to write portions of the picture more than two times with more than two offset positions of the addressing device to even further increase the resolution of the display. Alternatively, the resolution in the direction perpendicular to the direction of movement can be increased by giving the addressing device an offset in this perpendicular direction.

In an embodiment in accordance with the invention as defined in claim 7, the addressing means comprises a light source, and the bi-stable display comprises a photoconductive layer and a display substance being sandwiched between a first conductive layer and a second conductive layer. The first conductive layer is directed towards the light source and is optically transparent for passing the light of the light source to the photoconductive layer. The display substance is for example an electrophoretic layer or a cholesteric texture LCD. Any display substance which provides a bi-stable display is suitable.

If light impinges at a particular location on the photoconductive layer, its conductivity locally increases. At this particular location, a major part of the voltage supplied between the first and the second conductive layers will be present across the display substance and will influence its optical state. If no light impinges on the photoconductive layer at the particular location, its impedance is locally very high. The voltage between the first and the second conductive layers will occur substantially across the photoconductive layer and substantially no voltage will occur across the display substance. Thus, at this particular location, the optical state of the display substance will not change. Such an optically addressed display is disclosed in the not yet published European Patent Application filed as 03100941.8.

The use of an addressing device which directs light towards the display has the advantage that the display is addressable without making contact with the display. The display can be rolled in and out without wearing its surface by the addressing device.

In an embodiment in accordance with the invention as defined in claim 8, the addressing device comprises a line of light sources. The light sources are arranged in a line substantially perpendicular with respect to the direction of movement of the display with respect to the addressing device, for example when it is un-rolled. Preferably, the line of light sources covers the complete width of the display. Preferably the light sources are positioned along the line at equidistant positions with respect to each other. The number of light sources in the line determines the resolution of the display.

When the display is at a position along the direction of movement with respect to the addressing device where a line of data has to be provided to obtain a corresponding line of pixels on the display, the addressing device controls the light sources of the line to produce light in accordance with an image to be displayed at this position. At a next position along the direction of movement of the display the addressing device controls the light sources to produce light in accordance with the image to be displayed at this next position. In this manner, the image is written on the display line by line while the display is being moved with respect to the addressing device or the other way around. The addressing device has a simple construction as it only needs to control one line of light sources. The amount of light produced by a particular light source depends on the information which needs to be displayed at the corresponding position on the display.

The addressing device may comprise several lines of light sources to address several lines of pixels of the display at the same time to increase the writing speed. This might be relevant if the display can be unrolled very fast.

The display again has the same simple construction. The construction of the display does not depend on the number and arrangement of the light sources of the addressing device.

In an embodiment in accordance with the invention as defined in claim 9, the display comprises a display substance sandwiched between a protective insulating foil and a conductive layer. The addressing device comprises a first electrode being directed towards the display. The first electrode does not make contact with the display. A second electrode with a hole, preferably a circular electrode, is arranged in-between the first electrode and the display. A driver generates a relatively high voltage between the first and the second electrode to obtain an electron beam which is directed towards the display via the hole in the second electrode. An addressing voltage is supplied between the second electrode and the conductive layer of the display.

The voltage between the first and the second electrode has a level sufficiently high to obtain an electron beam directed towards the display substance to influence the optical state of the display substance. The voltage between the second electrode and the conductive layer is controlled to display the desired information on the display while it moves along the addressing device. Again the information is written into the display without requiring mechanical contact of the addressing device with the surface of the display.

In an embodiment in accordance with the invention as defined in claim 10, the addressing device comprises a line of electrodes. The electrodes are arranged in a line substantially perpendicular with respect to the direction of movement of the display when the display and the addressing device are moving with respect to each other. Preferably, the line of electrodes covers the complete width of the display. Preferably the electrodes are positioned along the line equidistant with respect to each other. The number of electrodes in the line determines the resolution of the display.

Again, the image is written on the display line by line while the display is being rolled in or out, or more generally when the display and the addressing device are moving with respect to each other. The addressing device has a simple construction as it only needs to generate voltages for one line of electrodes. The voltage at a particular electrode depends on the information which needs to be displayed at the corresponding position on the display.

The addressing device may comprise several lines of electrodes to address several lines of pixels on the display at the same time to increase the writing speed. This might be relevant if the display can be unrolled very fast.

In an embodiment in accordance with the invention as defined in claim 11, the display comprises a display substance sandwiched between a protective insulating foil and a conductive layer. The addressing device comprises a mechanical slider which makes mechanical contact with the protective insulating foil. A driver generates a voltage between the mechanical slider and the conductive layer. This embodiment in accordance with the invention operates in the same manner as the embodiment described earlier with respect to claim 5. The level of the voltage between the mechanical slider and the conductive layer can be lower than the level of the voltage required between the first and the second electrode. It is not required to generate electrons, it suffices to generate an electrical field across the display substance. However, the slider may cause wear of the surface of the display.

In an embodiment in accordance with the invention as defined in claim 12, the addressing device comprises a line of mechanical sliders. The mechanical sliders are arranged in a line substantially perpendicular with respect to the direction of movement of the display when the display and the addressing device are moving with respect to each other, for example when the display rolled in or out the holder. Preferably, the line of mechanical sliders covers the complete width of the display. Preferably the mechanical sliders are position along the line equidistant with respect to each other. The number of mechanical sliders in the line determines the resolution of the display.

When the moving display is at a position along the direction of movement where a line data has to be provided to obtain a corresponding line of pixels on the display, the addressing device supplies voltages to the mechanical sliders of the line in accordance with an image to be displayed at this line position of the display. At a next position along the direction of movement of the display the addressing device supplies voltages to the mechanical sliders in accordance with the image required at this next position of the display. In this manner, for example, the image is written on the display line by line while the display is being rolled in or out. The addressing device has a simple construction as it only needs to supply voltages to one line of mechanical sliders. The voltage at a particular mechanical slider depends on the information which needs to be displayed at the corresponding position on the display.

The addressing device may comprise several lines of electrodes to address several lines of pixels on the display at the same time to increase the writing speed. This might be relevant if the display can be rolled in or out very fast.

In an embodiment in accordance with the invention as defined in claim 13, a position of the display with respect to the active area of the addressing device is determined. In this manner it is known during the movement of the display and the addressing device with respect to each other what the position of the display with respect to the addressing device is. The addressing device is synchronized to address pixels on the display based on the position determined. Thus, the information to be displayed is provided by the addressing device to the display at the correct position.

If the speed of moving of the display and the addressing device is constant and known, such a synchronization is not required. For example, it is possible to detect when the unrolling starts and thus when the addressing device should start addressing the display. If the information has to be written on the display at equidistant positions in the direction of the movement, the addressing device is controlled to address the display at equidistant instants. However, if the speed of unrolling is not constant or not known, the information will not be written on the correct position. For example, a non constant speed of unrolling causes the lines of information to be displayed by the display at non equidistant positions. A non-constant speed of unrolling may in particular occur if the unrolling is hand operated. If the unrolling is motor operated the synchronizing may not be required.

In an embodiment in accordance with the invention as defined in claim 15, the position of the display is indicated by a simple potentiometer which is coupled to the axis which keeps the display when rolled up. The resistance of the potentiometer indicates how far the display is unrolled. The addressing device is synchronized with the rotational position of the potentiometer and thus the axis. The addressing device will address the display at predetermined values of the resistance of the potentiometer. The predetermined resistance values may be stored in a look-up table. Every time the resistance of the potentiometer is equal to a predetermined resistance value stored, the data corresponding to the position of the display is supplied to the addressing device.

In an embodiment in accordance with the invention as defined in claim 16, markers are provided. A detector detects the position of the markers. The addressing device uses these detected positions to write the information to the display on the correct positions. The markers can de provided in many ways, but they have to be positioned in the direction of the movement of the display when it is rolled in or out. Preferably, the markers are arranged along an edge of the display, on the display itself or on a strip attached to the display. The markers may have magnetic properties which are detected by a magnetic field sensor, for example a small coil.

The markers may be optical as defined in the embodiment in accordance with the invention as defined in claim 17. For example, the markers are small holes in the display or in a strip attached to the edge of the display. A light source, for example a LED, supplies light in the direction of the holes at one side of the holes, a light sensitive sensor is arranged at the other side of the holes. Light will impinge on the sensor when a hole is in front of the sensor. The markers may have a reflectivity which differs from the surroundings. The amount of light which reaches the sensor via the reflective dot indicates that a marker is detected.

In an embodiment in accordance with the invention as defined in claim 18, an optical movement detector is used to detect the markers. Such an optical movement detector per se is known from optical mice for computers and operates in the same manner to detect an speed and a direction of movement.

These and other aspects of the invention are apparent from and will be elucidated with reference to the embodiments described hereinafter.

In the drawings:

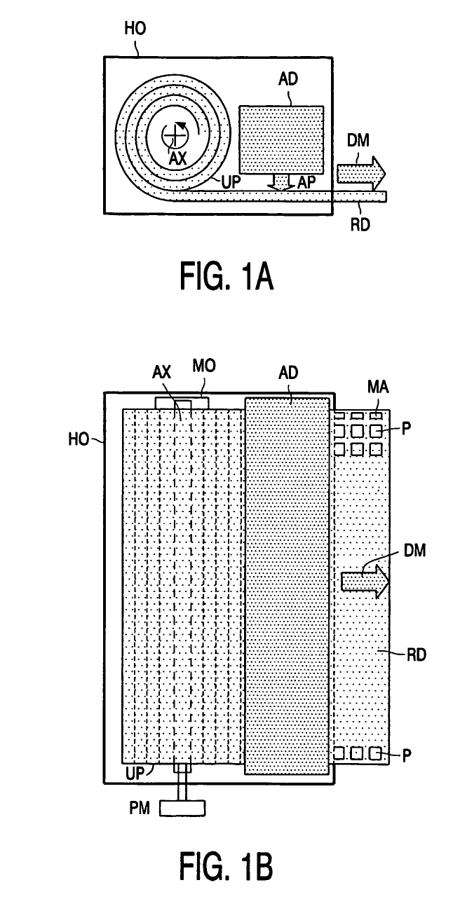

FIG. 1 shows a rollable display in a container which comprises an addressing device,

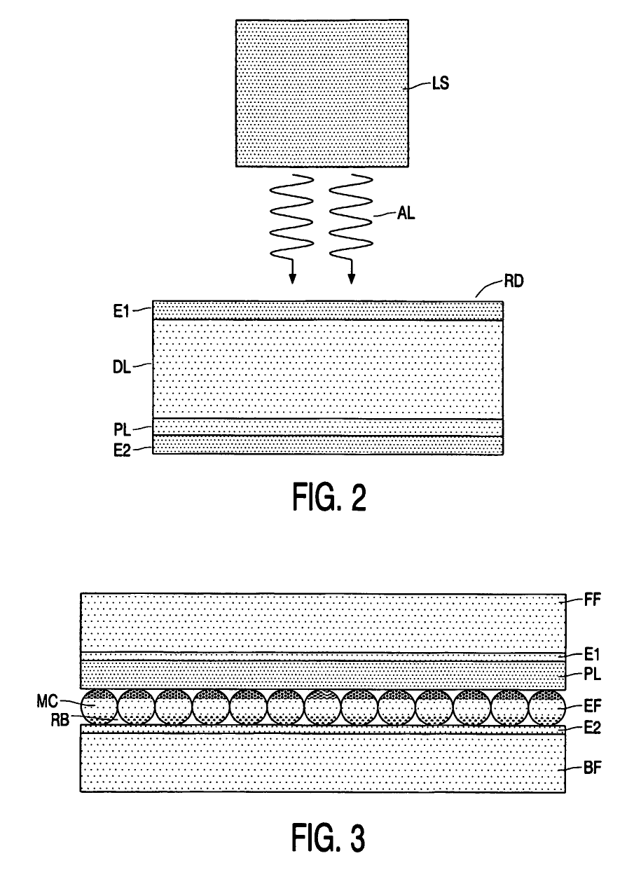

FIG. 2 shows an optically addressed rollable bi-stable display,

FIG. 3 shows an optically addressable electrophoretic display,

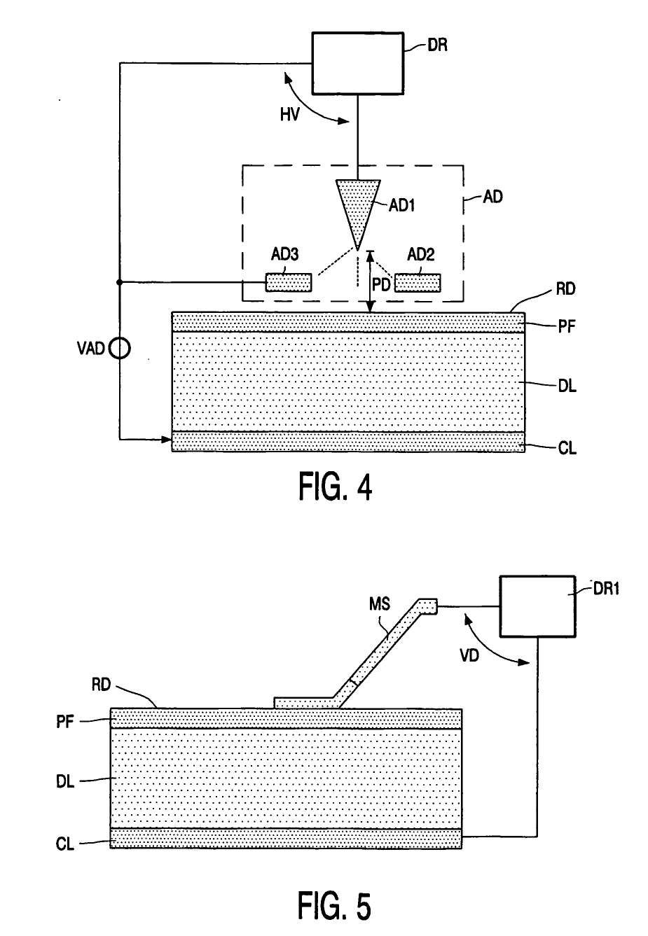

FIG. 4 shows a rollable bi-stable display which is addressed with an electric field without making contact with the display,

FIG. 5 shows a rollable bi-stable display which is addressed with an electric field by mechanical sliders making contact with the surface of the display, and

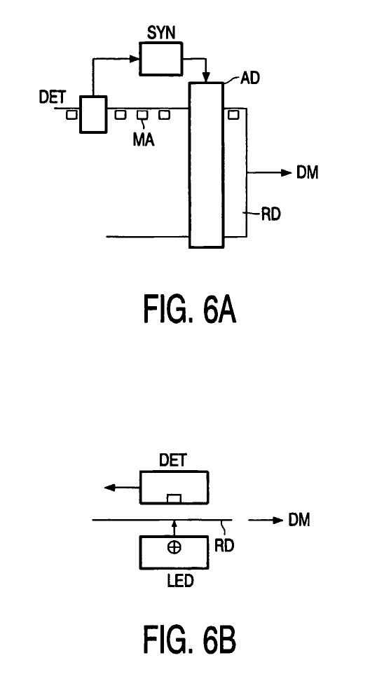

FIG. 6 shows an embodiment in accordance with the invention for synchronizing the addressing with the amount of unrolling of the display.

The same references in different Figures refer to the same entities.

FIG. 1 shows a rollable display in a container which comprises an addressing device.

FIG. 1A shows a cross-section of the container HO. The container HO comprises the rollable display RD of which a part UP is rolled up around an axis AX. The unrolled part of the display RD partly extends out of the container HO. During the unrolling of the display RD, it moves in the direction indicated by the arrow DM along the addressing device AD. The addressing device AD addresses the display RD at the position or area AP.

FIG. 1B shows a top view of the display which is partly rolled-up in the container HO. The display RD is in the same position as shown in FIG. 1A. FIG. 1B shows the part UP of the display RD which is rolled up around the axis AX, the addressing device AD positioned on top of the display RD, and the part of the display RD which extends out of the container HO.

The addressing device AD addresses the display RD when being unrolled. Preferably, the addressing device AD addresses a line of pixels P extending in the direction substantially perpendicular to the direction DM of movement of the display RD.

If the holder further comprises a motor MO which causes the display RD to be unrolled with a known constant speed, the addressing device AD may address the line of pixels P at equidistant time instants starting from the instant the front edge of the display RD reaches the position AP. Preferably, a synchronous electric motor is used.

If the display RD is unrolled by hand, the speed of unrolling is unknown and may vary. To be able to write the information on the display RD at the correct positions, the instants the addressing device AD addresses the line of pixels P should be synchronized with the position of the display RD. The position of the display may be determined with a potentiometer PM which is coupled to the axis AX to indicate the rotational position of the axis AX. The resistance of the potentiometer PM indicates the amount of unrolling of the display RD. The position of the display RD may also be indicated by markers MA. Preferably, these markers MA are provided at at least one edge of the display in the direction DM of the movement of the display RD when being unrolled. Preferably the markers indicate the position of a line of pixels P. The markers MA may be provided directly on the display RD or on a strip attached to the edge of the display RD.

The markers MA may, for example, be mechanical, magnetic or optical. The mechanical markers MA may be small dots of conductive material. These mechanical markers MA can be detected with a slider positioned to make contact with the dots. The magnetic markers MA may be small dots of magnetic material. These magnetic markers MA can be detected with a small coil. The optical markers MA may be small holes which, when in front of a light source, allow light to be detected by a light sensitive element. The optical markers MA may also be dots which have a reflectivity different than the reflectivity of the surrounding area. The markers MA can be used to determine the absolute position, while the resistance change of the potentiometer PM indicates the direction of movement. It is also possible to use an optical movement sensor to determine the position of the markers MA and the direction of movement of the display RD. Such an optical movement sensor as such is known from an optical mouse used in computer systems. Now, the potentiometer PM is not required.

An embodiment in accordance with the invention of the synchronization of the addressing device AD with the position of the display RD is described with respect to FIG. 6. Embodiments in accordance with the invention of the addressing device AD and the construction of the display RD able to be addressed by the addressing device AD are described with respect to FIGS. 2 to 6.

FIG. 2 shows an optically addressed rollable bi-stable display. In this embodiment in accordance with the invention, the addressing device AD comprises a light source LS which generates light AL. The bi-stable display RD comprises a stack of layers, which seen from the light source LS occur in the order: a top electrode E1, a display substance DL, a photoconductive layer PL, and a bottom electrode E2. The photoconductive layer PL may also be sandwiched between the top electrode E1 and the display substance DL.

The top electrode E1 is transparent, preferably, the top electrode E1 is a transparent conductive ITO layer. The display substance DL may be any substance suitable to be operated as a bi-stable display. A bi-stable display is a display of which the optical state does not change when no voltage is applied across it. Examples of bi-stable displays are electrophoretic displays and cholesteric texture LCD's. The photoconductive layer PL comprises a material of which the resistance at a particular location depends on an amount of light impinging at this particular location. The bottom electrode is a conductive layer, which preferably is a metal or ITO layer.

In a mode of the display RD wherein it sensitive to the light AL, a voltage is supplied between the top electrode E1 and the bottom electrode E2. If the light AL impinges at a particular location on the photoconductive layer PL, its conductivity locally increases. At this particular location, a major part of the voltage supplied between the top and the bottom conductive layers E1 and E2 will be present across the display substance DL and will influence its optical state. If no light impinges on the photoconductive layer PL, its impedance is very high. The voltage between the top electrode E1 and the bottom electrode E2 will occur substantially across the photoconductive layer PL and substantially no voltage will occur across the display substance DL, the optical state of the display substance DL will not change.

It is thus possible to change the optical state of the display substance DL with a simple addressing device AD which preferably comprises an area (a line or a matrix) of light sources LS. The area of light sources LS is driven to address a corresponding area of pixels on the display RD. The addressing device AD needs to address a small area of the display RD only. The complete display RD will be addressed because it moves along the addressing device AD. Preferably, the addressing device AD addresses a line of pixels P at a time. The line of pixels P extends substantially perpendicular to the direction DM of movement of the display RD and over the complete width of the display RD. This allows addressing the display RD line by line while it moves along the addressing device AD. If the addressing device AD does not cover the complete width of the display RD, the addressing device AD may be moved in the direction substantially perpendicular to the direction DM, for example as is known from printer heads.

If the addressing device is allowed to move, the resolution of the pixels P is not longer limited by the spacing of the light sources LS of the addressing device AD. For example, if the complete display moves along the addressing device AD two times at slightly shifted positions of the addressing device AD, the resolution is twice as high. For example, it is possible to write data to the display during the rolling-up of the display with the addressing device AD at a first position with respect to the housing, and during the unrolling of the display with the addressing device AD at a second position with respect to the housing. Preferably, the first and the second position are shifted in the direction of the rolling of the display such that the positions with respect to the display interleave.

Also, the construction of the display RD is very simple, no matrix display is required, the top electrode E1 and the bottom electrode E2 may cover the complete top and bottom of the display, respectively. It is not required to use segmented intersecting electrodes and active elements to be able to address the pixels P individually.

FIG. 3 shows an optically addressable electrophoretic display. This embodiment of thee optically addressable electrophoretic display comprises a stack of the next consecutive layers: a back foil BF, a back electrode E2, an electrophoretic layer EF, a photoconductive foil PL, a front electrode El, and a front foil FF. Other optically addressable electrophoretic displays are possible. In the embodiment of the electrophoretic display shown, the electrophoretic layer EF comprises microcapsules MC and a binder RB in-between the microcapsules MC. Such an electrophoretic display is also referred to as e-ink (electronic ink) display, and the electrophoretic layer EF is also referred to as e-ink layer. The microcapsules MC are filled with colored particles. In the display shown, each microcapsule MC comprises white and black particles which are oppositely charged. The particles are moved in the microcapsules MC by supplying a voltage and thus an electric field across the microcapsules MC. The voltage supplied between the front electrode E1 and the back electrode E2 occurs across the series arrangement of the photoconductive foil PL and the electronic ink layer EF. If light impinges at a particular location on the photoconductive foil PL, the conductivity of the photoconductive foil PL increases. At this particular location, a major part of the voltage supplied between the electrodes E1 and E2 will be present across the electrophoretic layer EF and the optical state of the microcapsule(s) at this location will be influenced by this voltage.

As both the photoconductive foil PL and the electrophoretic layer EF have a capacitance, the voltage applied to the electrodes E1 and E2 will be capacitively tapped during the level changes. Therefore, when the display is activated, this voltage has to be increased sufficiently slowly, such that the voltage across the electrophoretic layer EF stays low enough. If the voltage rises to steep, due to the capacitive division, the voltage across the electrophoretic layer EF may become too large and influence its behavior. After the voltage has been applied sufficiently slowly, the writing of the data with the addressing light can start. After the writing operation, the voltage should slowly decrease, again to prevent undesired voltages across the electrophoretic layer EF which may influence the optical behavior of the electrophoretic layer EF.

It is possible to use this capacitive division to erase the display. If a sufficiently high voltage is applied sufficiently fast, the electrophoretic layer EF will change into one of its optical limit situations: for example, it will become completely black or white if black and white particles are used. This allows bringing the display RD in a well defined initial state before the addressing device AD writes the information to the display RD when it is pulled out of the container HO.

Further, the capacitance of the electronic ink layer EF has the drawback that a voltage across the electrophoretic layer EF will leak away only slowly. Thus after removing the voltage across the electrodes E1 and E2, still a voltage will be present across the microcapsules MC causing the optical state of the microcapsule to further change.

Both drawbacks can be alleviated by giving the microcapsules MC and/or the binder RB a predetermined conductivity. The predetermined resistance of the electrophoretic layer EF can be selected to lower the influence of the capacitive division, and this predetermined resistance increases the drop of the voltage across the electrophoretic layer EF. Such an optically addressed electrophoretic is disclosed in the not yet publish European Patent Application filed as 03100941.8.

FIG. 4 shows a rollable bi-stable display which is addressed with an electric field without making contact with the display.

The display comprises a stack of three layers which seen from the electrode AD1 are a protective insulating foil PF, the display substance DL and the conductive layer CL.

The addressing device AD comprises an electrode AD1 which preferably has a sharp point direction towards the display RD to obtain a high electric field. The end of the pointed electrode AD1 has a non-zero distance PD with respect to the surface of the display RD such that no mechanical contact occurs between the electrode AD1 and the surface of the display RD. The electrodes AD2 and AD3 in-between the tip AD1 preferably are a cross-section of a substantially single circular extraction electrode.

A driver DR supplies a relatively high voltage HV between the electrode AD1 and the electrode AD2, AD3 to create electrons towards the display substance DL. An addressing voltage VAD is applied between the electrode AD2, AD3 and the conductive layer CL to obtain an electric field across the display substance DL. Preferably, the high voltage HV is supplied continuously, and the addressing voltage VAD is adapted per pixel Pij to write information to the pixel Pij. It is also possible to supply a the high voltage HV to only the pixels Pij which should change their optical state. If the voltage HV is supplied, the electrons will cause the display substance DL to change its optical state.

It is thus possible to change the optical state of the display substance DL with a simple addressing device AD which preferably comprises an area (a line or a matrix) of electrodes AD1. The area of electrodes AD1 is driven to address a corresponding area on the display RD. The addressing device AD needs to address a small area of the display RD only. The complete display RD will be addressed because it moves along the addressing device AD. Preferably, the addressing device AD addresses a line of pixels P at a time. The line of pixels P extends substantially perpendicular to the direction DM of movement of the display RD and over the complete width of the display RD. This allows addressing the display RD line by line while it moves along the addressing device AD. If the addressing device AD does not cover the complete width of the display RD, the addressing device may be moveable in the direction substantially perpendicular to the direction DM, for example as is known from printer heads.

Also, the construction of the display RD is very simple, no matrix display is required, the protective insulating foil PF and the conductive layer CL may cover the complete top and bottom of the display, respectively. It is not required to use segmented intersecting electrodes and active elements to be able to address the pixels P individually.

FIG. 5 shows a rollable bi-stable display which is addressed with an electric field by mechanical sliders making contact with the surface of the display. This embodiment in accordance with the invention operates in the same manner as the embodiment described with respect to FIG. 4. The electric field is now generated by a mechanical slider MS which makes contact with the protective insulating foil PF, and the voltage VD supplied by the driver DR1 between the mechanical slider and the conductive layer CL. The advantage of this approach is that the level of the voltage VD may be smaller than the level of the voltage HV. It is not required to generate electrons towards the display material DL.

The display RD may be identical to the display described with respect to FIG. 4. Again, preferably an array of sliders MS is used to address an array of pixels P at a time, in a same manner as discussed with respect to FIG. 4.

FIG. 6 shows an embodiment in accordance with the invention for synchronizing the addressing with the amount of unrolling of the display.

FIG. 6A shows a top view of the display RD showing the positions of the markers MA. FIG. 6B shows a side view of the display RD, the light source LED, and the light sensitive device DET.

The markers MA are positioned along an edge of the display RD in the direction DM of movement of the display. A light source LED preferably comprises a light emitting diode which is positioned beneath the display and directs light towards the markers MA. The markers MA are small holes in the display RD or in a strip attached to the edge of the display RD. The detector DET comprises a light sensitive element which is positioned opposite to the light source LED. The detector DET supplies a signal to the synchronization circuit SYN indicating when a marker hole MA passes the light beam of light source LED. The synchronization circuit SYN controls the addressing circuit AD to address the area of pixels P at the correct position such that the correct information is written at the correct position on the display RD.

It should be noted that if is referred to pixels P of or on the display RD, it is not meant to refer to actual hardware cells in the display RD. The display RD may have a homogeneous construction, the pixels P are only referred to as areas of the display RD which are present due to the addressing of the display RD with the discrete light sources LS, pointed electrodes AD1 or mechanical sliders MS of the addressing device AD.

It should be noted that the above-mentioned embodiments illustrate rather than limit the invention, and that those skilled in the art will be able to design many alternative embodiments without departing from the scope of the appended claims.

The bi-stable display need not be a matrix display. Passive and segmented displays can be used as well. However, for high resolution applications where arbitrary content has to be displayed, matrix addressing is required, and usually active matrix addressing.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system comprising
a bi-stable display (RD),
an addressing means (AD) for locally addressing the bi-stable display (RD), and
a means for moving (MO) the addressing means (AD) and the bi-stable display (RD) with respect to each other.

2. A system as claimed in claim 1, wherein the bi-stable display (RD) is rollable, and wherein the system further comprises a means for holding (HO) the rollable bi-stable display (RD) in a rolled up position, and for allowing the rollable bi-stable display (RD) to be unrolled, and wherein the addressing means (AD) is arranged for locally addressing the rollable bi-stable display (RD) while being rolled in and/or out the means for holding (HO).

3. A system as claimed in claim 1, wherein the addressing means (AD) is a unit mechanically separated from the bi-stable display (RD).

4. A system as claimed in claim 1, wherein the addressing means (AD) is mechanically fixed to the means for holding (HO).

5. A system as claimed in claim 1, wherein the addressing means (AD) is movably fixed to the means for holding (HO) for providing at least two different positions with respect to the means for holding (HO).

6. A system as claimed in claim 1, wherein the addressing means (AD) is arranged in a first position with respect to the means for holding (HO) when said display (RD) is passing the addressing means (AD) for a first time, and wherein the addressing means (AD) is arranged in a second position with respect to the means for holding (HO) when said display (RD) is passing the addressing means (AD) for a second time, the second position having an offset with respect to the first position in a direction of movement of said display (RD) and the addressing means (AD) with respect to each other, or in a direction perpendicular to the movement of said display (RD) and the addressing means (AD) with respect to each other.

7. A system as claimed in claim 1, wherein the addressing means (AD) comprises a light source (LS), and wherein the bi-stable display (RD) comprises a photoconductive layer (PL) and a display substance (DL) being sandwiched between a first conductive layer (E1) and a second conductive layer (E2), the first conductive layer (E1) being directed towards the light source (LS) and being optically transparent for passing the light (AL) of the light source (LS) to the photoconductive layer (PL).

8. A system as claimed in claim 7, wherein the addressing means (AD) comprises at least one line of light sources (LS) extending substantially perpendicular with respect to a direction of movement (DM) of the bi-stable display (RD) and the addressing means (AD) with respect to each other.

9. A system as claimed in claim 1, wherein the bi-stable display (RD) comprises a display substance (DL) sandwiched between a protective insulating foil (IF) and a conductive layer (CL), the addressing means (AD) comprises a first electrode (AD1) being directed towards the bi-stable display (RD) but not making contact with the bi-stable display (RD), and a second electrode (AD2, AD3) positioned in-between the first electrode (AD1) and the protective foil (PF), the system further comprises a driver (DR) for generating a voltage (HV) between the first electrode (AD1) and the second electrode (AD2, AD3) to obtain an electron beam, the second electrode (AD2, AD3) having a hole for allowing the electron beam to pass towards the display substance (DL) of the bi-stable display (RD) when said display (RD) and said addressing means are being moved with respect to each other.

10. A system as claimed in claim 9, wherein the addressing means (AD) comprises
at least one line of first electrodes (AD1) extending substantially perpendicular with respect to a direction of movement (DM) of the bi-stable display (RD) with respect to the addressing means (AD), and ending at a predetermined distance (PD) with respect to a surface of the bi-stable display (RD), and wherein the system further comprises a driver (DR) for generating voltages (HV) being supplied between the line of first electrodes (AD1) and a corresponding line of second electrodes to supply electrons to at least one line of pixels (P).

11. A system as claimed in claim 1, wherein the bi-stable display (RD) comprises a display substance (DL) sandwiched between a protective insulating foil (IF) and a conductive layer (CL), the means for addressing (AD) comprises a mechanical slider (MS) making contact with the protective insulating foil (IF), and the system further comprises a driver (DR1) for generating a voltage (VD) between the mechanical slider (MS) and the conductive layer (CL).

12. A system as claimed in claim 11, wherein the means for addressing (AD) comprises at least one line of mechanical sliders (MS) extending substantially perpendicular with respect to a direction of movement (DM) of the bi-stable display (RD) with respect to the addressing means (AD), and making contact with the protective insulating foil (IF), and wherein the system further comprises a driver (DR1) for generating voltages (VD) between the mechanical sliders (MS) and the conductive layer (CL).

13. A system as claimed in claim 1, wherein the system further comprises
means (PM; LED, DET, AM) for determining a position of the bi-stable display (RD) with respect to the addressing means (AD), and
synchronizing means (SYN) for synchronizing the addressing means (AD) to address pixels (P) of the bi-stable display (RD) based on the position determined.

14. A system as claimed in claim 2, wherein the system further comprises
means (PM; LED, DET, AM) for determining a position of the rollable bi-stable display (RD) while being rolled in or out, and
synchronizing means (SYN) for synchronizing the addressing means (AD) to address pixels (P) of the rollable bi-stable display (RD) based on the position determined.

15. A system as claimed in claim 14, wherein the means (PM; LED, DET, AM) for determining the position comprise a potentiometer (PM) coupled to an axis (AX) around which the rollable bi-stable display (RD) is rolled up when in a rolled up state, a resistance of the potentiometer (PM) indicating an amount the rollable bi-stable display (RD) is rolled in or out.

16. A system as claimed in claim 13, wherein the means (PM; LED, DET, AM) for determining the position comprises markers (MA) on or coupled to the bi-stable display (RD) and a detector (DET) for detecting the markers (MA).

17. A system as claimed in claim 16, wherein the means (PM; LED, DET, AM) for determining the position further comprises a light emitting device (LED), and wherein the detector (DET) comprises a light sensitive element, the markers (MA) being areas with an optical behavior different than that of surrounding areas, the light emitting device (LED) and the light sensitive element being positioned with respect to the markers (MA) to enable detection of the markers (MA).

18. A system as claimed in claim 13, wherein the detector (DET) comprises an optical movement detector.

19. A system as claimed in claim 7, wherein the display substance is an electrophoretic material (EF) or cholesteric texture liquid crystal material.

20. A method of addressing a bi-stable display (RD), the method comprising
locally addressing (AD) the bi-stable display (RD), and
moving (DM) the addressing means (AD) and the bi-stable display (RD) with respect to each other.

21. A method of addressing a bi-stable display (RD) as claimed in claim 20, the method comprising unrolling the bi-stable display (RD), and the locally addressing (AD) is performed during rolling in or out the bi-stable display (RD).
